(19) United States
(12) Patent Application Publication
(10) Pub. No.: US 2009/0055319 A1
(43) Pub. Date: Feb. 26, 2009

(54) Novel card-less, name-less, number-less, and paper-less method and system of highly secure completely anonymous customer-merchant transactions

(76) Inventor: Fazal Raheman, Dubai (AE)

Correspondence Address: Fazal Raheman, Suite 217, Twin Towers, P Box 4404, Dubai, 4404, AE

(21) Appl. No.: 11/892,187

(22) Filed: Aug. 21, 2007

(51) Int. Cl. G06Q 40/00

(52) U.S. Cl. 705/44

(57) ABSTRACT

In this novel method the online authentication of an authorized user is accomplished without transmitting any of the user's personal information over the public or private networks. The method is so versatile that it can be deployed not only for conducting online financial transactions, but any conceivable form of virtual and physical authentication of a user, such as physical access to a locked facility, ticket less travel, driver's license or passport verification. Since the personal user information is never revealed or transmitted through the networks the method secures the transaction from online frauds without the need for data encryption.

### STATEMENT REGARDING FEDERALLY SPONSORED RESEARCH OR DEVELOPMENT

Not Applicable

### REFERENCE TO A MICROFICHE APPENDIX

Not Applicable

### TECHNICAL FIELD

An improved method and system of executing highly secure and private online transactions in any financial, non-financial, real or virtual setting, which is extremely versatile, user friendly and entails absolutely no disclosure or transmission of any of the transaction parties' personal account information. The present invention relates generally to a novel client-server-client network architecture that connects a wireless communication network device of the customer as the first client terminal and a merchant device as the second client terminal with a remote server for a highly secure anonymous transaction.

### BACKGROUND OF THE INVENTION

Online transactions are omnipresent. They affect every aspect of the modern life. Whether paying at the grocery store, or purchases made on the Internet, or catching a flight to visit one's family, or even simply accessing email requires a process of verification and authentication of the authorized individual. All facilities in a physical world or services in a virtual world of Internet can only be accessed by presenting a credential of the authorized user. So the individual's personal information is communicated to the facility or service provider who authenticates the information and then authorizes access. In the process of transmitting such confidential identification information to the service provider/merchant, the information is susceptible to be stolen by ID thieves who can use the ID to access the facilities or services secured by such IDs. The world's GDP is an estimated $60 trillion; the global capital stock market is worth $118 trillion. Each of these tens of trillions of dollars moves from one location to another several times in a given year carrying with it the identification of its origin and its destination. According to one estimate the global financial loses alone on account of ID thefts are projected to be in access of $200 billion.

Accordingly, there is a need for a system for securing all kinds of online transactions whether done on the Internet or in the physical world of brick and mortar outfits, whether involving money exchange, customer identification or any type of service access. The invention described herein overcomes the limitations of the prior art.

### BRIEF SUMMARY OF THE INVENTION

In a co-pending application this inventor has described several embodiments of an encryption-independent platform for achieving Network Integrity via Digital Authorization (NIDA). In that application several embodiments are described for securing authenticity Of Web pages by preventing a spoofed website from delivery to the client. Such Network Integrity was achieved by embedding a 2-dimensional barcode image on a specific location on every protected page. The NIDA barcode encoded the IP address of the authorized server. Every request for such a page triggered a scan of the NIDA barcode. If the barcode did not resolve to the IP address of the authorized server than the page was rejected. While in that application this inventor described a novel method establishing authenticity of Web pages and preventing fraudulent Web pages from circulation, in the instant novel invention the unprecedented network integrity is achieved by completing the transaction itself without any disclosure of confidential user account information. If transactions are completed without disclosure or presentation of any form of personal account information to the merchant, there would be nothing for the fraudsters to steal.

It would be an improvement to provide a new method of conducting highly secure online transactions that require no disclosure or presentation of customer's name or account number or physical identification to the merchant. Consequently, it is an advantage of the invention that such online transactions are completely immune from ID theft, because there are no IDs to be stolen.

It is therefore an object of the present invention to provide a user Friendly, portable, highly versatile and yet very secures method of conducting all the Different types of online transactions. The invention overcomes the problems residing in the prior art. It is another object of the invention to provide a key-less, card-less, nameless, numberless method of access that replaces conventional keys, cards and even the user identification, password for accessing any type of facility or service in a real physical world or a virtual world, in which the access code disclosure device is a wireless device such as a mobile phone.

It is yet another object of the present invention to provide a wireless device resident digital code to access secured facilities or services. It is still another object of the invention to provide a secure dynamic access code that is randomly generated in real time by the transaction server. It is yet another object of the instant invention to integrate all possible high security access needs of an individual in a single device. It is also another object of the invention to provide an all-inclusive comprehensive tool for customer relationship management in general and customer loyalty programs in particular. It is still another object of the invention to provide a method of secure ticket-less travel, passenger authentication and immigration check.

The foregoing discussion summarizes some of the more pertinent objects of the present invention. These objects should be construed to be merely illustrative of some of the more prominent features and applications of the invention. Applying or modifying the disclosed invention in a different manner can attain many other beneficial results or modifying the invention as will be described. Accordingly, referring to the following drawings may have a complete understanding of the invention. Description of the preferred embodiment is as follows.

### BRIEF DESCRIPTION OF THE SEVERAL VIEWS OF THE DRAWINGS

FIG. 1 is a block diagram illustrating the network architecture of a preferred embodiment implemented in a merchant in-store point-of-sale scenario.

FIG. 2 is a block diagram illustrating the network architecture of a preferred embodiment implemented in a merchant Web-based virtual terminal scenario.

FIG. 3 is a block diagram illustrating the network architecture of a preferred embodiment implemented in a merchant mobile point-of-sale scenario.

FIG. 4 is a block diagram illustrating the network architecture of a preferred embodiment implemented in a high security Web Mail scenario.

FIG. 5 is a block diagram illustrating the network architecture of a preferred embodiment implemented in a frequent flyer program scenario-I.

FIG. 6 is a block diagram illustrating the network architecture of a preferred embodiment implemented in a frequent flyer program scenario-II.

FIG. 7 is a block diagram illustrating the network architecture of a preferred embodiment implemented in a high security locked premises scenario.

FIG. 8 is a block diagram illustrating the network architecture of a preferred embodiment implemented in an airline check-in/immigration/boarding scenario.

### DETAILED DESCRIPTION OF THE INVENTION

For the purpose of this description the term online transaction includes not only a traditional online transaction but any process that requires authenticating or verifying an authorized user of a facility. The term merchant not only includes a traditional merchant in a commercial transaction but any governmental or non-governmental agency that administers, controls and regulates virtual or physical access to a facility by issuing identification to the authorized users of the facility. The term customer includes any individual who is authorized to use specific facilities by presenting his or her identification issued by the authorized administrator of the facility.

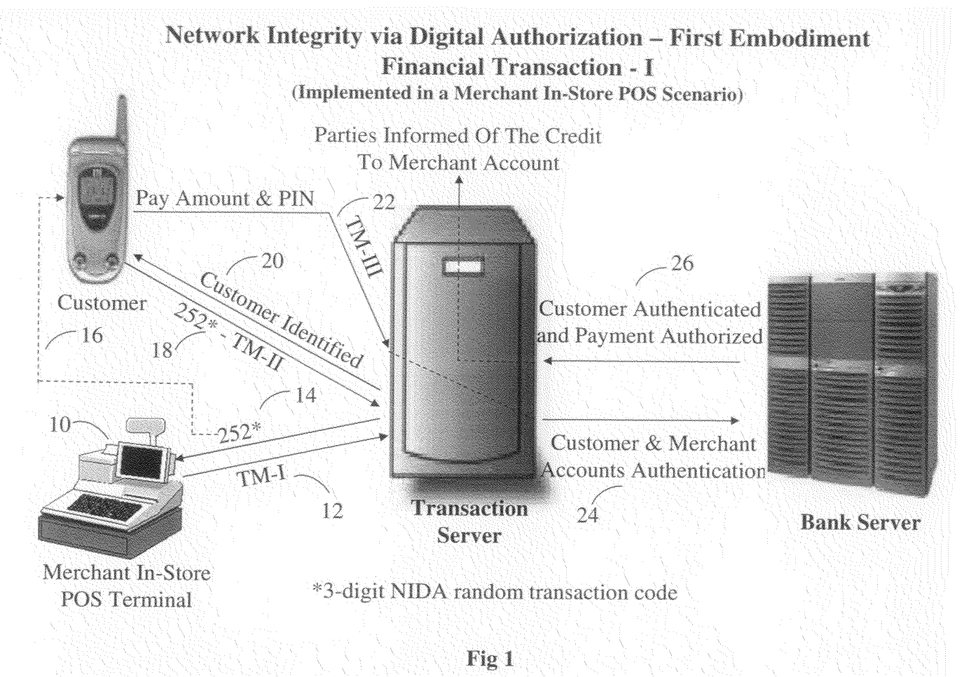

The novel features of the instant invention can be deployed in any physical or virtual world scenario. However the preferred embodiment of the invention is described, as it would be implemented as payment method in a physical brick and mortar store's point-of-sale (POS) terminal. As represented in FIG. 1 one of the preferred embodiments of the present invention is implemented through a client-server-client network of four nodes. In the embodiment described herein, all client-server data transfer between the wired or wireless nodes is implemented either by using SMPP (short message peer-to-peer protocol) or via WAP (Wireless Application Protocol) or HTTP. All peer to peer communication between the wireless nodes takes place via radiofrequency transmission.

The practical implementation of a preferred embodiment begins with the customer at Node-I making purchases at the store and using his mobile phone-based credit account. The merchant at Node-II point-of-sale terminal uses the transaction device 10 to initiate the online payment of the customer's purchases. The transaction device sends a text message of payment due to the transaction server 12, which returns to the Node-II merchant device, a dynamically generated string of digits comprising of not less than two and not more than seven numerals or alphabets or combination thereof (Network Integrity Digital Authorization Code—NIDA Code) 14, for example the code 252. See Figures I, II, III, IV, V, VI and VII. Such NIDA code remains valid for a few minutes not exceeding 30 minutes. Within such time period the merchant delivers to the code to the customer for authorizing the payment 16, and the customer promptly enters the code in his Node-I mobile phone device 18 for transmitting the code to the Node-III Transaction Server, using either the text messaging protocol or the voice protocol. Once the transaction server receives the dynamic NIDA code e.g. code 252 from Node-I, it checks the validity of the dynamic code by verifying the source and time the code was generated and delivered. If both the customer and merchant devices are identified and the code is still unexpired, the transaction server, using the text messaging 20 or voice protocol, sends the customer device an advise to enter the payment amount and customer's personal identification number (PIN). The customer then enters the payment amount and the PIN in his mobile transaction device and sends it to the transaction server using either the text messaging protocol or voice protocol 22. The transaction server then submits the customer and merchant identification to the Node IV Bank Server 24 for customer and merchant account authentication. The Bank Server authenticates the parties and authorizes the payment to the merchant 26. The transaction server finally communicates the consummation of the transaction to the parties 28.

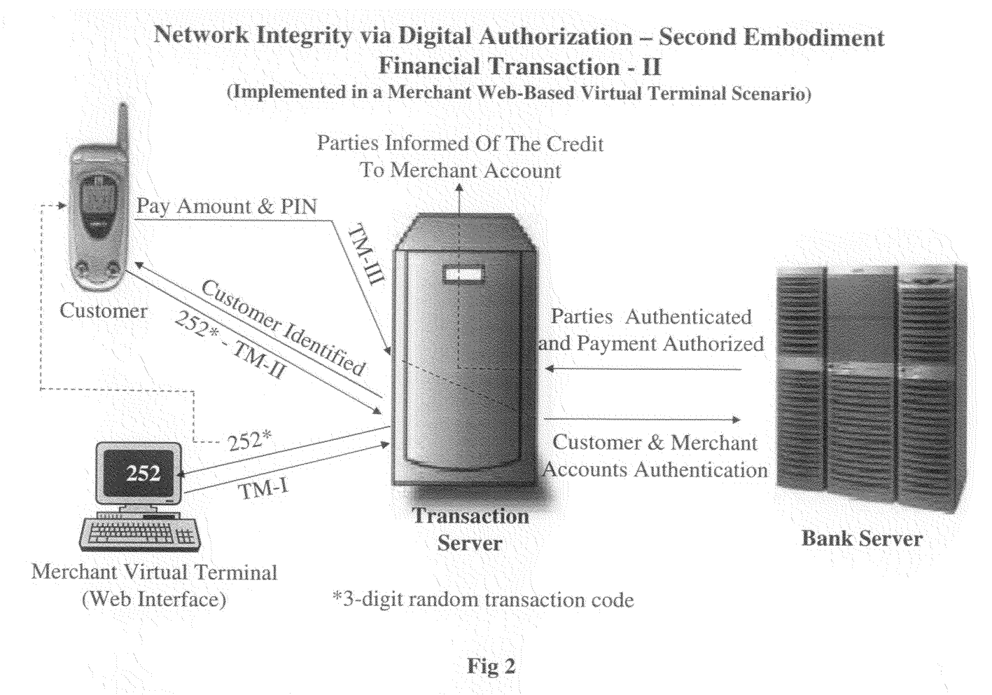

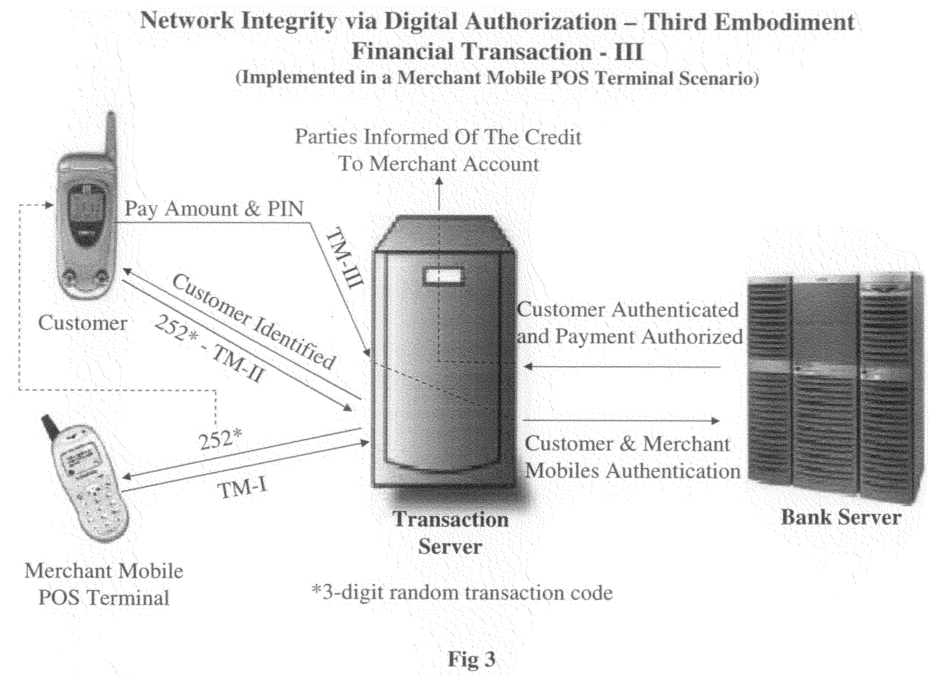

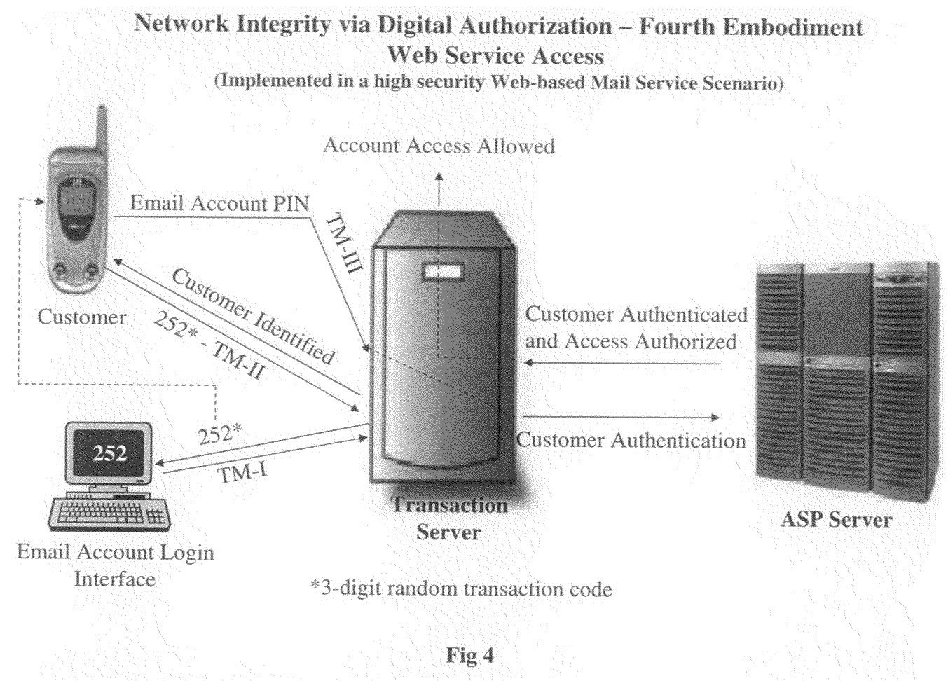

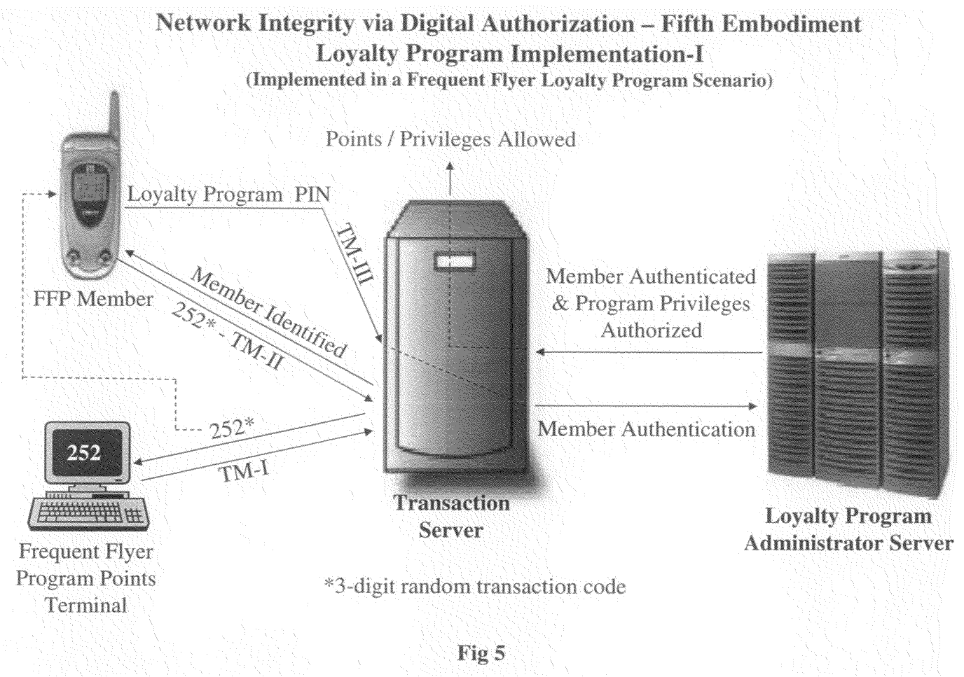

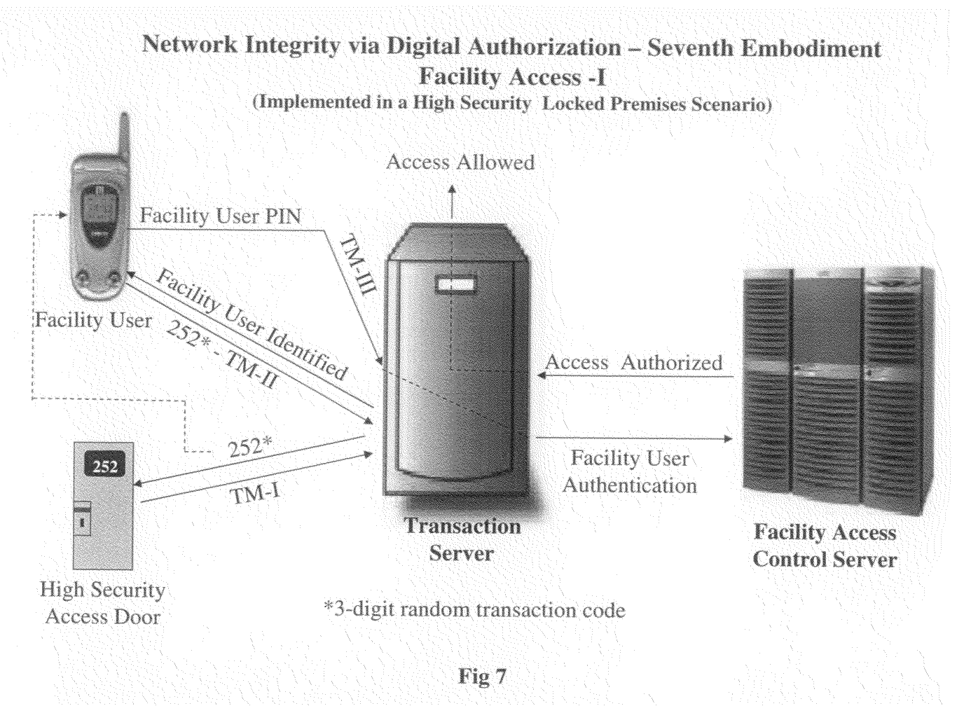

The first preferred embodiment is just one example of deploying the instant invention. Seven other preferred embodiments are illustrated in the block diagrams of a network architecture based on the first preferred embodiment and presented in self explanatory drawings in FIGS. 2 through 8. See FIG. 2-FIG. 8.

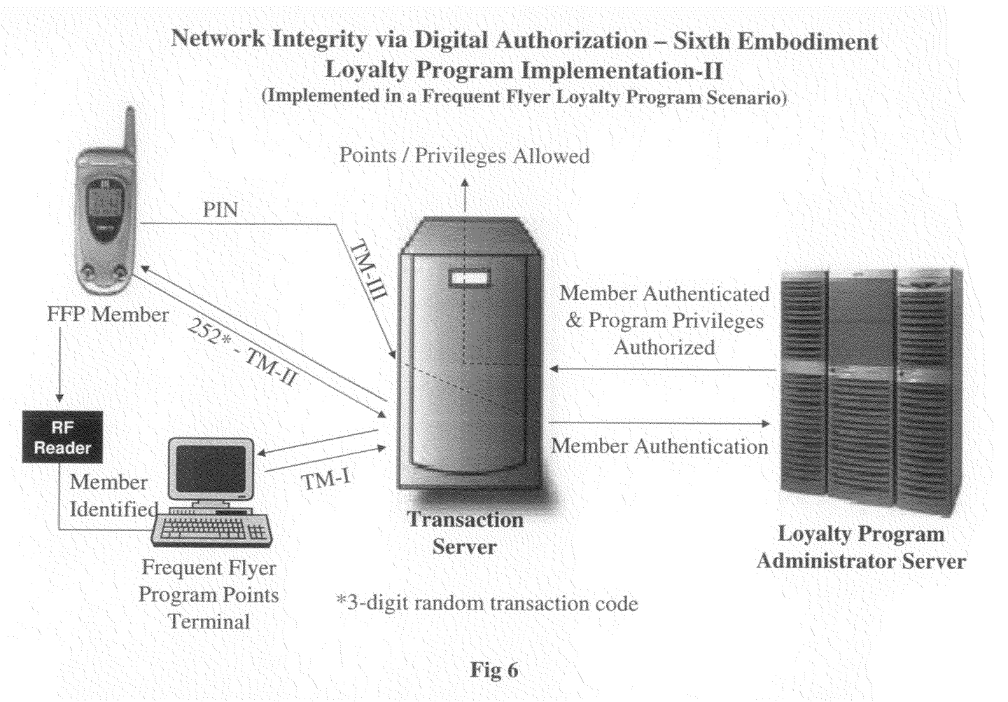

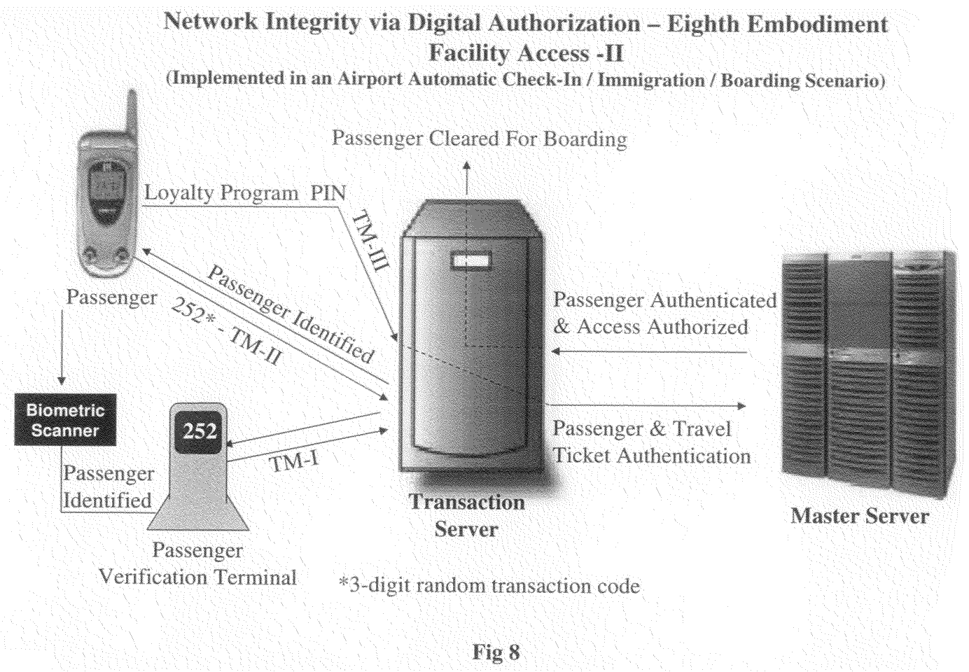

In the above description of the first of the preferred embodiments the client server-client network is initiated by the merchant. Alternately the implementation of the method can also be initiated by the customer in which case the customer delivers the dynamic NIDA code to the merchant for authentication. In both of these instances the online transaction is initiated by either of the transaction parties by commanding his or her transaction device to contact the remote transaction server. However such online transaction can also be automatically initiated by using direct peer to peer radiofrequency (RF) communication between the customer's mobile phone and the merchant terminal. FIG. 6. In this method the customer's mobile phone carries a user specific RF transponder, which directly communicates with the merchant terminal's RF transceiver/reader when brought in close proximity and automatically triggers the dynamic code generation from the transaction server. The rest of the routines remain the same. In yet another variant of the invention, especially in a physical access to a high security facility scenario, the method can also be initiated by a biometric scanner installed on the merchant terminal. FIG. 8. Such biometric scanner is either a finger print scanner, iris scanner, signature scanner, voice scanner or a facial scanner. Some of the common examples of such high security physical access settings are passenger verification, passport and driver's license verification, travel ticket/boarding pass authentication etc.

Although the above implementations refer primarily to text messaging and 20 voice protocol for communications between Nodes I, II and III, any communication protocol or combination thereof known to the art can be deployed to implement the novelty of card-less, name-less, number-less anonymous transaction of the instant invention. Although the above implementations refer to eight different scenarios, these scenarios are only illustrations. The principles apply equally to any other scenario for accessing physical world premises and services, or accessing virtual world arenas and services with high level of security and privacy.

The present invention has been shown in the described embodiments for illustrative purposes only. Further, the terms and expressions which have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims which follow.

What I claim as my invention is:

1. A novel card-less, name-less, number-less and paper-less, method and system of executing highly secure, confidential and completely anonymous online transaction between an authorized customer and an authorized merchant by means of an authorized customer transaction device, an authorized merchant transaction device, a remote transaction server hosting the authorized customer and merchant accounts, and a time sensitive dynamic transaction code generated randomly by the transaction server when contacted by either of the transaction devices, such that the dynamic code is unique to that particular transaction between that specific merchant and that specific customer for that particular time.

2. The method of claim 1, wherein the customer transaction device is a hand held wireless data, voice, video communication device connected to the remote transaction server by means of either a wireless Internet connection, or wireless telecommunication network, and identified by means of its telephone number or IP address or a unique customer identification code embedded either in its subscriber identity module or encoded within an integrated radiofrequency transponder (RF) inlay.

3. The method of claim 1, wherein the authorized merchant transaction device is either wired or a wireless device connected to the remote transaction server by means of either a wired/wireless Internet connection, or wired/wireless telecommunication network, and identified by its telephone number or IP address or unique merchant identification code resident in the device's central processor chip or in its RF transceiver/reader module or in its biometric scanner module.

4. The method of claim 1, wherein the merchant transaction device is:
a. payment authenticator,
b. an automatic teller machine,
c. bank teller customer authenticator,
d. passenger ticket authenticator,
e. facility access authenticator,
f. law enforcement biometric scanner for customer's biometric identification by means of customer's finger print scan, iris scan or facial scan, as initiator of the secure transaction for the purpose of verification driver's license, passport or any form of physical identification of citizens.

5. The method of claim 1, wherein the transaction is initiated by either a customer device or a merchant device, whether via the telecommunication network using either SMPP (short message peer-to-peer protocol) or via WAP (Wireless Application Protocol) or HTTP, or via a direct peer to peer customer/merchant contact using either the RF Module or the biometric module.

6. The method of claim 5, wherein the direct peer to peer RF communication between the customer and merchant deploys radio waves in the high frequency range generally between 3 MHz to 30 MHz, but preferably a working frequency of 13.56 MHz and at a read distance between the two devices of not less than 1 cm and not more than 10 ft.

7. The anonymous online transaction of claim 1, whether it is a money transfer in a financial transaction, or a user identification for any purpose, or a service access method, or a facility access control method, and whether it is conducted through a real brick and mortar point-of-sale or access control terminal, or through a virtual Internet terminal.

8. The method of claim 1, wherein the personal customer account is a type of:
a. financial banking account including checking, savings or mortgage account, credit or debit card account or stock trading account;
b. email, web service, government entitlement, driver's license, passport or personal identification account;
c. customer relationship management (CRM)/customer loyalty program account including but not limited to frequent flyer program, frequent guest program, frequent renter program.
d. passport, driver's license, travel ticket or boarding pass for physical access authorization to a high security facility.

9. The time sensitive dynamic transaction code of claim 1, wherein the code is more than two and less than seven numerals or alphabets or combination thereof generated randomly by the remote transaction server, delivered and displayed on either of the transaction devices on either party's request, and remains valid for transaction for not less than two minutes but not more than thirty minutes, enabling an anonymous online customer-merchant transaction requiring no disclosure of personal customer identification or account information.

10. The dynamic transaction code of claim 9, wherein the code displayed in one party's transaction device, is populated within the time limitation of claim 9, in the transaction code field of the other party's transaction device, either using the keyboard buttons, or handwritten with writing stylus, or by voice, for transmitting the transaction code to the transaction server for the biometric verification and authentication of the parties to each other and to the transaction server.

11. The method of claim 1, wherein the authorized customer is finally authenticated for that particular transaction by the transaction server, which upon receiving a valid dynamic transaction code retrieves the parties' personal account or biometric information from a remote server hosting customer and merchant accounts, for the purpose of consummating the customer desired transaction.

12. A novel method of executing highly secure, private and confidential online transaction between a customer and a merchant anonymously without disclosure or transmission of any form of customer's personal information or customer account number via a network of Internet compatible nodes comprising of:
a. Authorized Customer Node (Node 1), which is a wired or wireless data, voice, video communication device the digital identification of which is registered with the Node 3 Transaction Server in the form of a telephone number or IP address or unique customer identification code not less than three digits and not more than twelve digits as a digital watermark or firmware algorithm embedded in its subscriber identity module chip or in its radiofrequency (RF) transponder chip;
b. Authorized Merchant Node (Node 2), which is a wired or wireless data, voice or video communication device, or a Web page interface displayed on a computer terminal, the digital identification of which is registered with the Node 3 Transaction Server in the form of a telephone number or IP address or a unique merchant identification code not less than three digit and not more than twelve digits resident in the device's central processor chip or/and in its RF transceiver/reader module, or in its biometric scanner module;
c. The Transaction Server Node (Node 3), which is a remote server hosting the digital IDs of the registered customers and merchants, which generates and delivers a time sensitive dynamic transaction code in response to a transaction request from either of the transaction initiating nodes, i.e. either Node 1 or Node 2;
d. Accounts Database Node (Node 4), which is a quarantined remote server/servers that host the database personal information and accounts of all the authorized customers and authorized merchants.

13. The online transaction of claim 12, whether it is a money exchange in a financial transaction, a customer identification for any purpose, or a service access method or a facility access method, and whether it is through a real brick and mortar point-of-sale terminal or through a virtual Internet terminal.

14. The method of claim 12, wherein the Node 2 merchant device is:
a. payment authenticator,
b. an automatic teller machine,
c. bank teller customer authenticator,
d. passenger ticket/boarding pass authenticator,
e. facility access authenticator,
f. law enforcement biometric scanner for customer's biometric identification by means of customer's finger print scan, iris scan or facial scan, as initiator of the secure transaction for the purpose of verification of driver's license, passport or any form of physical identification of citizens.

15. The method of claim 12, wherein the transaction is initiated by either a customer device or a merchant device, whether via the telecommunication network using either SMPP (short message peer-to-peer protocol) or via WAP (Wireless Application Protocol) or HTTP, or via a direct peer to peer customer/merchant contact using either the RF Module or the biometric module.

16. The method of claim 14, wherein the direct peer to peer RF communication between the customer and the merchant deploys radio waves in the high frequency range generally between 3 MHz to 30 MHz, but preferably a working frequency of 13.56 MHz and at a read distance between the two devices of not less than 1 cm and not more than 10 ft.

17. The time sensitive dynamic transaction code of claim 12, wherein the code is more than two and less than seven numerals or alphabets or combination thereof generated randomly by the remote transaction server, delivered and displayed on either of the transaction devices on either party's request, and remains valid for transaction for not less than two minutes but not more than thirty minutes, enabling a confidential online customer-merchant transaction requiring no disclosure or transmission over public networks of customer's personal identification or account information.

18. The dynamic transaction code of claim 17, wherein the code displayed in one party's transaction device, is populated within the time limitation of claim 17, in the transaction code field of the other party's transaction device, either using the keyboard buttons, or handwritten with writing stylus, or by voice, for transmitting the transaction code to the transaction server for the biometric verification and authentication of the parties to each other and to the transaction server.

19. The method of claim 12, wherein the online transaction between the customer and the merchant is a credit/debit card payment, banking deposit/withdrawal/transfer, a virtual passenger travel ticket/boarding pass, virtual access account authentication code, or physical entry into a controlled facility.

20. The method of claim 12, wherein the personal customer account is a type of:
a. financial banking account including checking, savings or mortgage account, credit or debit card account or stock trading account;
b. email, web service, government entitlement, driver's license, passport or personal identification account;
c. customer relationship management (CRM)/customer loyalty program account including but not limited to frequent flyer program, frequent guest program, frequent renter program;
d. passport, driver's license, travel ticket or boarding pass for physical access authorization to a high security facility.

21. The method of claim 12, wherein the authorized customer is finally authenticated for that particular transaction by the Node 3 transaction server, which retrieves the specific customer account information and the merchant account information from the Node 4 remote server hosting customer and merchant accounts, for consummating the customer desired transaction.
